(19) United States
(12) Patent Application Publication
(10) Pub. No.: US 2007/0208704 A1
(43) Pub. Date: Sep. 6, 2007

(54) Packaged mobile search results

(76) Inventor: Stephen Ives, Cambridgeshire (GB)

Correspondence Address: BARNES & THORNBURG LLP, P.O. BOX 2786, CHICAGO, IL, 60690-2786, US

(21) Appl. No.: 11/369,025

(22) Filed: Mar. 6, 2006

(51) Int. Cl. G06F 17/30

(52) U.S. Cl. 707/3

(57) ABSTRACT

A query server (50) provides a mobile search service, by fetching search results corresponding to the search query (180), preparing (200) a package (261) containing more than one page defined by a mark up language, and sending the package to a mobile device (10), across a wireless network (20). A browser (15) running on the mobile device presents the pages. A user can browse the results with a conventional browser quickly without having to wait for each page to be downloaded over the network, and without having to download and run a custom application. Having page boundaries in the search results, rather than having all the results in a single page, can reduce laborious scrolling, reduce the number of clicks needed to find an item of interest, or enable more items to be sent and browsed.

### RELATED APPLICATIONS

This invention relates to earlier U.S. patent application Ser. No. 11/189,312 filed Jul. 26, 2005, entitled “processing and sending search results over a wireless network to a mobile device” and Ser. No. 11/232,591, filed Sep. 22, 2005, entitled “Systems and methods for managing the display of sponsored links together with search results in a search engine system” claiming priority from UK patent application no. GB0519256.2 of Sep. 21, 2005, and to Ser. No. 11/289,078 filed Nov. 29, 2005 entitled “Display of search results on mobile device browser with background process”, the contents of which applications are hereby incorporated by reference in their entirety.

### FIELD OF THE INVENTION

This invention relates to query servers for providing a mobile search service, to corresponding methods of using a mobile search service, and corresponding apparatus and software.

### DESCRIPTION OF THE RELATED ART

The world wide web is a massive store of useful (and useless) information. A good search tool enables general purpose access to this information store. Searching the world wide web is a well solved problem when accessing the web from a desktop personal computer (e.g. Google, Yahoo, et al). Mobile devices that are capable of accessing content on the world wide web are being increasingly numerous. However, pages designed specifically for the small screen sizes of mobile devices are very few. Further, there are only a few very simple search services available to mobile devices. These search services perform poorly for several reasons:
there are not enough mobile-specific pages available today to provide relevant pages for most search queries (although this is changing as more mobile-specific web sites are created)
desktop-specific webpages cannot be easily rendered on the limited screen and limited browsers of mobile devices,
direct translation of desktop-specific webpages to the specific markup language supported by most mobile devices (eg XHTML Basic and XHTML Mobile Profile) is a hard problem, and
network requests suffer high latency regardless of the high bandwidths increasingly available, this means every click by a user on a link takes several seconds for a response regardless of the size of the response.

The information held in the world wide web is therefore very hard to access from a mobile device and particularly from a handset with a small screen. Search results are typically a page of links to candidate pages. Sometimes these links are accompanied by snippets of text from the candidate pages to assist the user in determining relevancy. The user must then click on these links in turn, possibly skipping seemly irrelevant links, in order to test or check whether the linked page contains the desired information. This process works fine for a search when using a desktop personal computer connected using a good dial-up or broadband internet connection. It works less well for a mobile device. Search engines for use from mobile devices can be arranged to use conventional browsers on mobile devices, for displaying web pages (for example Google™ mobile), or a custom client application can be installed by the user on their mobile device to run instead of the browser (for example Nokia “mobile search application”) so that search results need not be sent in web page format. The browser-based mobile search engines enable use from a wider range of different devices, but operation is slower. The slower network bandwidth and much higher connection latencies of a wireless network means each click to download a page takes at least 2-3 seconds and sometimes several seconds. Google™ Mobile sends less information about each hit in the search results, than its standard search, and uses transcoding of web pages to fit smaller screens typical of handheld devices. This reduces the amount of data sent over the wireless network, but is only partially successful and still suffers high latencies. The search results are still sent as a single page with a list of results including approximately 10 to 20 words as a summary for each result in the list. Testing ten or twenty pages, a typical number required to find target information, can therefore take many minutes. Further, both the list of results and each target page are still larger than the small displays of many handheld mobile devices and so must usually be scrolled (often slowly by the limited capabilities of browsers found on handheld mobile devices) line by line, since the keypads of handheld mobile devices typically have no page up or page down keys. On conventional browsers, once a results page has been downloaded to a browser for display, the dialogue with the server is completed. To alter or update the page being displayed usually needs the browser to send a new page request to the server, the server to send the new page as XHTML, and the browser to interpret the received XHTML to display the page. Hence the mobile search user experience is very poor and solutions already marketed have very low usage.

This has led to custom application-based mobile search engines to address the slowness, and improve the user experience. The custom application enables faster download since little or no page formatting information need be sent compared to the XHTML pages needed for browser-based searching. Interaction with the search results is no longer limited to scrolling the current page or downloading a new page. The user has the inconvenience of having to download and install the custom application and keep it updated. The search engine provider has the inconvenience of providing versions of such a custom application for a range of different mobile devices and managing updates for the many versions.

It is also known to provide browsers which attempt to render and display some parts of a web page before the complete page is downloaded. This technique, sometimes referred to as progressive rendering, has varied support. Some mobile browsers although displaying parts of a web page before the complete page has been downloaded do not allow for user interaction until the page has been completely downloaded. Others do not finalise the layout of all items of the page until the page has been fully downloaded. This can often lead to an adjustment of the shape and or position of the parts of the page the user has started to look at.

### SUMMARY OF THE INVENTION

Amongst others, an object of the invention is to provide improved mobile search. Various aspects of the invention are set out in the independent claims. Dependent claims and embodiments provide various subsets within the scope of the independent claims. Many others are possible. Some are based on a recognition of the drawbacks of known arrangements, and/or a recognition that claimed features can provide advantages. Some are notable for sending to a mobile device a package containing pages defined by a mark up language so that a browser running on the mobile device can selectively present the pages.

Numerous variations and modifications can be made without departing from the claims of the present invention. Therefore, it should be clearly understood that the embodiments of the present invention described in detail are illustrative only and not intended to limit the scope of the claims of the present invention.

### BRIEF DESCRIPTION OF THE DRAWINGS

How the present invention may be put into effect will now be described by way of example with reference to the appended drawings, in which:

FIG. 1 shows schematically an overview of some of the principal entities involved in an embodiment of the invention,

FIG. 2 shows some principal actions of a query server according to an embodiment,

FIG. 3 shows some principal actions of a browser on a mobile device of a user, according to an embodiment,

FIG. 4 shows representations of a package having multiple XHTML pages according to an embodiment, before and after a custom transform,

FIG. 5 shows a sequence of actions of a browser, query server and search engine according to an embodiment,

FIG. 6 shows a schematic view of the appearance of a screenview movable to view part of a package having pages having results, some of which have images,

FIG. 7 shows an overview of a search engine system, according to an embodiment, and

FIG. 8 shows some of the principal actions of the system of FIG. 7.

### DETAILED DESCRIPTION

At least some of the embodiments of the invention provide a query server arranged to provide a mobile search service, and arranged to respond to a search query by fetching search results corresponding to the search query, the query server being arranged to prepare a package containing more than one page defined by a mark up language, the pages containing the search results, and send the package to a mobile device, across a wireless network, for presentation by a browser running on the mobile device capable of selectively presenting the pages.

A notable consequence is that the problems caused by latency of the wireless network can be avoided or hidden from the user. The old slow scroll+click+load+browse of one search result at a time which gave a poor user experience is replaced by a single download of multiple pages. This means a user can browse the results with a conventional browser quickly without having to wait for each page to be downloaded over the network, and without having to download and run a custom application. Having page boundaries in the search results, rather than having all the results in a single page, can help a user to navigate through the results more quickly or more easily. This helps avoid the delays and frustration of scrolling laboriously line by line. This can help reduce the number of clicks needed to find an item of interest, or enable more items to be sent and browsed. It exploits the fact that browsers on mobile devices typically support a user input device such as an up/down/left/right key, joystick, pointer or wheel, for moving a display focus or cursor or selecting a highlighted option. A user of the browser can navigate between the pages and each result page can itself be scrolled if necessary. Such scrolling can be limited to that page and so be limited to a screenview or one or more results so that a user can hold a scroll button down to scroll rapidly without the inconvenience of scrolling past the next result or screenview. Another consequence of page boundaries is that each result page can use all 12 access keys (keypad shortcuts to hyperlinks) on a conventional numeric keypad of a handheld device, whereas if all results are in one page, the set of 12 keys can only be used once across all the results. Again this can enable faster navigation through the results. Another consequence of page boundaries is that each page can use the title bar displayed in many mobile browsers (set by the <title> XHTML tag), where previously one title had to be shared by all results. Particularly for handheld device displays with typically 10 to 15 lines of text, it is useful if an extra line can display useful information, such as information specific to results being displayed.

Another consequence of page boundaries is that navigation between pages can be arranged in XHTML more naturally with standard page links as opposed to the less reliably implemented (varies from browser to browser) bookmark, or anchor, links within the same page. Proper page links also means the browser back button works perfectly.

“Search results” are defined to encompass any of: a list of web site or WAP site names or titles, a list of web site or WAP site URLs, a number of summaries of content items of web sites, in text or other media formats, audio, image, video and other media content items, or combinations of these.

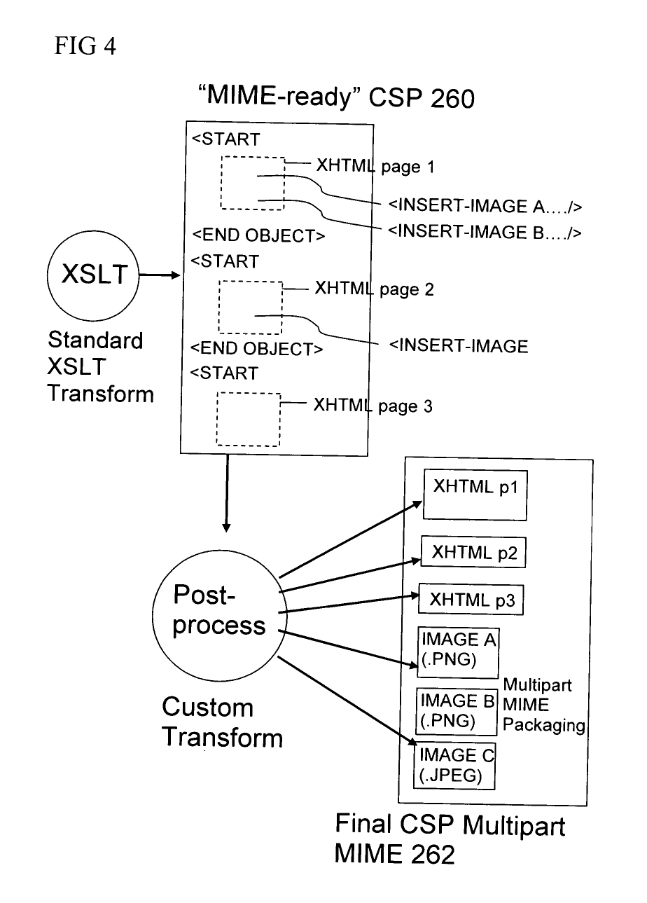

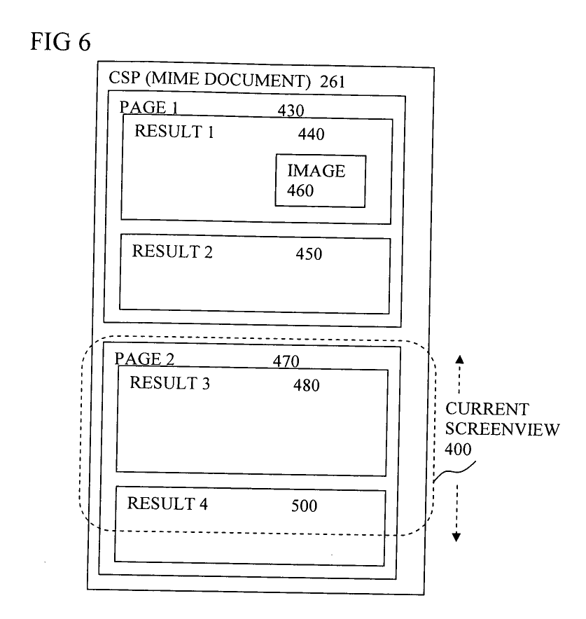

A package is defined as a group of pages capable of presentation by a browser and grouped in any way suitable for downloading together or in portions, in response to a single command. Packages are referred to below as content summary packages (CSP) and a multipart MIME (Multipurpose Internet Mail Extensions) CSP described below with reference to FIGS. 4 and 6 is an example of a package, and other equivalents can be envisaged.

A page is defined as any information capable of interpretation and presentation by a browser as a page, and can include HTML or XHTML or WAP pages for example. “Presenting” is intended to encompass displaying text or images, playing of audio or video media, and playing of an audio representation of text for example.

The term “browser” is intended to encompass software for retrieving and presenting items that are accessible online such as web or WAP pages in a mark up language, and encompasses microbrowser applications.

The term “wireless network” is intended to encompass cellular networks, GSM networks, GPRS networks, UMTS networks, WiFi networks and other wireless networks having potential for delays which are noticeable or inconvenient to a user browsing search results. The wireless network can encompass combinations of the above networks, and ultra wide band WiFi and meshed WiFi (arranged in a wireless mesh where each hop between base stations adds cumulative delay).

In some embodiments, the package comprises a multipart MIME document. MIME (Multipurpose Internet Mail Extensions) is a standard which is supported by a wide range of handheld devices and so helps enable the service to be widely accessible. This can keep down the costs for the service provider of maintaining different versions of the service to suit different devices.

In some embodiments, the server is arranged to insert one or more page boundaries between results. This can enable the user to navigate the screenview directly to the top of another result.

In some embodiments, the server is arranged to insert one or more page boundaries to coincide substantially with screenview boundaries. This can enable a user to browse through screenviews with little or no line scrolling.

In some embodiments, the server is arranged to insert inter page navigation hyperlinks. A user can use the browser to select these to navigate to another page. This can be easier than scrolling line by line, and can be more universally and reliably supported by browsers than intra page navigation links.

In some embodiments, the server is arranged to insert access key navigation hyperlinks. This enables more keys to be used for navigation and so can help reduce a number of key presses.

In some embodiments, the server is arranged to insert a title bar for one or more of the pages.

In some embodiments, the server is arranged to maintain a persistent record of the pages sent. This can enable a user to bookmark the pages and request them later from the service provider.

In some embodiments, the server is arranged to fetch the search results from a database of content summary objects (CSOs) extracted from source web pages. Content summary objects are defined and further described later in this document.

In some embodiments, the server is arranged to transform the search results. This transform can be to suit a characteristic of the user's mobile device, or according to other parameters. This means the search results can be fetched or stored in a device neutral format. This can make it much easier to adapt the service to different devices. In some embodiments, the server is arranged to insert page breaks after the transformation. This means the transforming can be easier than if page breaks are already inserted.

In some embodiments, the package contains one or more images, for inserting into the pages, and the transforming involves scaling one or more of the images. Again this means the images can be fetched or stored in a device neutral format.

In some embodiments, the server is arranged to fetch the search results in XML form, and arranged to use an XSLT stylesheet for the transformation, to output XHTML or HTML for the pages.

In some embodiments, the search results comprise an image for presentation as a mosaic of pages, and the server is arranged to convert the image into pages each having a portion of the image. This helps enable such images to be presented at different levels of zoom, and allows page-based navigation to different portions. This can be useful for maps or diagrams for example, which are conventionally difficult to present on small screens.

Some embodiments provide a method of providing a mobile search service in response to a search query, having the steps of: fetching search results corresponding to the search query, preparing a package containing more than one page defined by a mark up language, the pages containing the search results, and sending the package across a wireless network to a mobile device, for presentation by a browser running on the mobile device capable of selectively presenting the pages.

Some embodiments provide a method of using a mobile search service having the steps of: sending a search query to the mobile search service, receiving at a browser running on a mobile device, a package containing more than one page defined by a mark up language, the pages containing search results corresponding to the search query, and using the browser to selectively present the pages.

“Online content” is defined to encompass at least a web page, a WAP page, an extract of text, a news item, an image, a sound or video clip, an interactive item such as a game, and many other types of content for example. “Online” is defined to encompass at least items in pages on websites of the world wide web, items in the deep web (e.g. databases of items accessible by queries through a web page), items available internal company intranets, or any online database including online vendors and marketplaces.

A “keyword” can encompass a text word or phrase, or any pattern including a sound or image signature.

“Hyperlink” is defined to encompass at least hypertext, buttons, softkeys or menus or navigation bars or any displayed indication or audible prompt which can be selected by a user to present different content.

The term “subject category” is intended to encompass categories of subject matter of content items, for example where a query term has a number of meanings or contexts or will produce a number of clusters of related results.

The term “comprising” is used as an open-ended term, not to exclude further items as well as those listed.

“image” can encompass pictures, diagrams, maps, mosaics made up of multiple images, time sequences of images, animations, films, and so on.

“scripting language” is intended to encompass high-level programming languages such as JavaScript, ASP (Active Server Pages, which use ActiveX scripting), and Perl, that are interpreted by another program at runtime rather than compiled. Instructions in such languages can be embedded within a mark up language document such as an XHTML or HTML document, to process data to be viewed in a browser window for example.

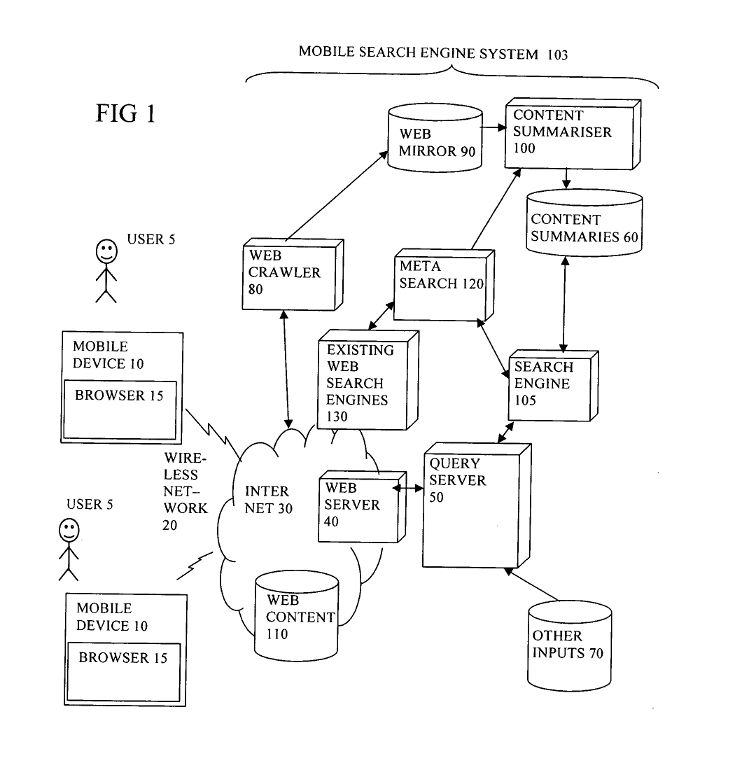

FIG. 1, Overall Topology

The overall topology of a first embodiment of the invention is illustrated in FIG. 1. FIG. 1 shows the Internet 30, and two mobile devices 10 of end users 5, coupled to the internet over a wireless network 20, and having browsers 15. In principle, the mobile devices could be coupled to other applications, for example in car computers with voice interfaces to enable users to search and obtain information from the web while driving. In FIG. 1, cylinder symbols represent stored information such as databases which may be implemented on a hard disc or in semiconductor memory for example, and may be distributed or local, and may be managed with appropriate back up and access security, following established practice. Cuboid shapes in this figure represent processes which may run as application software on their own server or be distributed or may share a server for example.

The search query is typically one or more keywords sent by the browser to the known internet address (URL) of the query server. It is sent as a request and is sent via a conventional protocol stack in the mobile device to enable communication over the wireless communications network. The protocol stack typically comprises the standard WAP or TCP/IP protocols which allow the mobile device to communicate with internet hosts and the transport and physical layer protocols, for example GPRS or the third generation UMTS protocols, that enable the mobile terminal to access and communicate data over the wireless communications network. The mobile terminal establishes a communications link to a WAP gateway or network access server (NAS) that interfaces the wireless network to the internet and routes the browser's request across the internet to the mobile search engine system 103. Web content (110) can include for example web pages, WAP pages, microformats (chunks of XML encapsulated by a web or WAP pages to describe items such as calendar events or other objects), RDF (resource description format) files (XML files relating to the semantic web to define relationships between information on pages), RSS feeds, and other web content.

The system comprises a number of elements as shown. A query server 50 is coupled to the internet via a web server 40. The query server passes the query to a search engine 105 which looks first in a database 60 of content summary objects, and in addition or instead, uses one (or more) existing web search engines 130 via a meta search engine 120. Meta search engines are well known and available commercially. Typically they will return a ranked search results list of URLs with or without an extract of text in response to the search query.

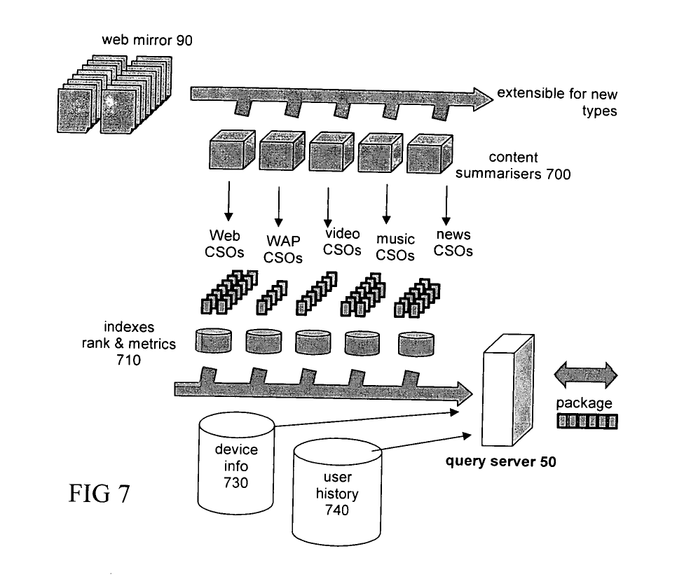

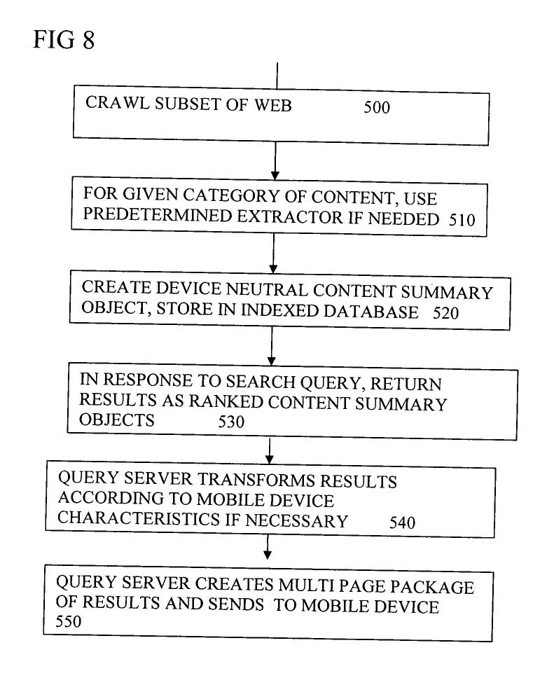

The database of content summary objects (CSOs) can be built up by a content summariser 100, from a web mirror 90. The web mirror holds a copy of online content found by a web crawler 80. Alternatively CSOs can be created from data derived from 3^{rd} party databases or from RSS feeds, or from other sources. The content summaries are typically extracts of important information from web pages, designed to be more suitable for sending across limited bandwidth networks, and for viewing or presenting on small screens of mobile devices. They may also be summaries of a WAP page, able to be displayed within a single screenview. These parts will be described in more detail below with reference to FIGS. 7 and 8.

Optionally the query server can operate as a front end only, in which case it could select a search engine of another organization at a remote location, which would use a content summariser and store of content summaries of that other organization or location. The functions remain similar wherever they are carried out or by which ever organization. Optionally the query server can be located at the interface between the wireless network and the internet, and be part of a service provided by the wireless network operator. The relevant content summaries are returned to the query server and formed into a package suitable for browsing on the mobile device of the user. Other inputs 70 are fed from a store to the query server for use in forming the package. Such other inputs can include advertising or news material for presenting to the user, or characteristics of the mobile device or its browser, characteristics of the wireless network channel, user location, user preferences and so on, for use in determining how much to send, and in what format and so on. These parts described form a mobile search engine system 103. The query server sends the package via the web server, the internet and the wireless network to the mobile user.

The system can be formed of many servers and databases distributed across a network, or in principle they can be consolidated at a single location or machine. The search engine can be consolidated with the query server in this case, and some, all or none of the back end parts used by the query server.

The users 5 connected to the Internet via mobile devices 10 can make searches via the query server. The users making searches (‘mobile users’) on mobile devices are connected to a wireless network 20 managed by a network operator, which is in turn connected to the Internet via a WAP gateway, network access server (NAS) or other similar device (using known principles and so not explained here in more detail). Many variations are envisaged, for example the content items can be elsewhere than the world wide web, and so on.

Description of Mobile Devices

The user can access the search engine from a mobile device such as any kind of mobile computing device, including laptop and hand held computers portable music players, portable multimedia players. Mobile users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface. These devices can typically run web browsers or microbrowser applications e.g. Openwave™, Access™, Opera™ Mozilla™ browsers, which can access web pages across the Internet. These may be normal HTML web pages, or they may be pages formatted specifically for mobile devices using various subsets and variants of HTML, including cHTML, WML, DHTML, XHTML, XHTML Basic and XHTML Mobile Profile. The browsers allow the users to click on hyperlinks within web pages which contain URLs (uniform resource locators) which direct the browser to retrieve a new web page.

Description of Servers

Although illustrated as a single server, the same functions can be arranged or divided in different ways to run on different numbers of servers or as different numbers of processes, or be run by different organisations.
The query server handles search queries from desktop PCs and mobile devices, passing them onto the other servers, and formats response data into web pages customised to different types of devices, as appropriate. Optionally the query server can operate behind a front end to a search engine of another organization at a remote location. Optionally the query server can carry out ranking of search results or this can be carried out by a separate ranking server. The query server is typically connected to a database that stores detailed device profile information on mobile devices and desktop devices, including information on the device screen size, device capabilities and in particular the capabilities of the browser or microbrowser running on that device. The database may also store individual user profile information, or individual profiles aggregated into group profiles, so that the service can be personalised to individual user or group needs. This may or may not include usage history information.

Web server programs can be separate or integral to the query server and other servers. These can be implemented to run Apache™ or some similar program, handling multiple simultaneous HTTP and FTP communication protocol sessions with users connecting over the Internet.

Operations:

Embodiments are concerned with improving the slow scroll+click+load+browse paradigm of one result at a time. Conventionally a user enters a query into the mobile device. The mobile device sets up a path for the query and response operation using e.g. WAP or TCP/IP protocols with the query server. This typically involves an exchange of many low level messages, adding to the delay or latency of the wireless network. This enables the keyword to be sent to the query server, which communicates with a search engine to return results in the form of titles, URLs and text extracts having the keywords. A page of these results in the form of an annotated list is sent to the mobile device. This download across the wireless network causes significant additional delay. The results page is then displayed by the mobile device. A user can then select one of the results and click on it to cause the browser on the mobile device to send a URL request. This can be routed across the wireless network to a transcoding engine which will access the original web page corresponding to that URL, and reformat it into a form suitable for display on the screen of that mobile device. If this document is not quite what the user wants, the request and download process is repeated.

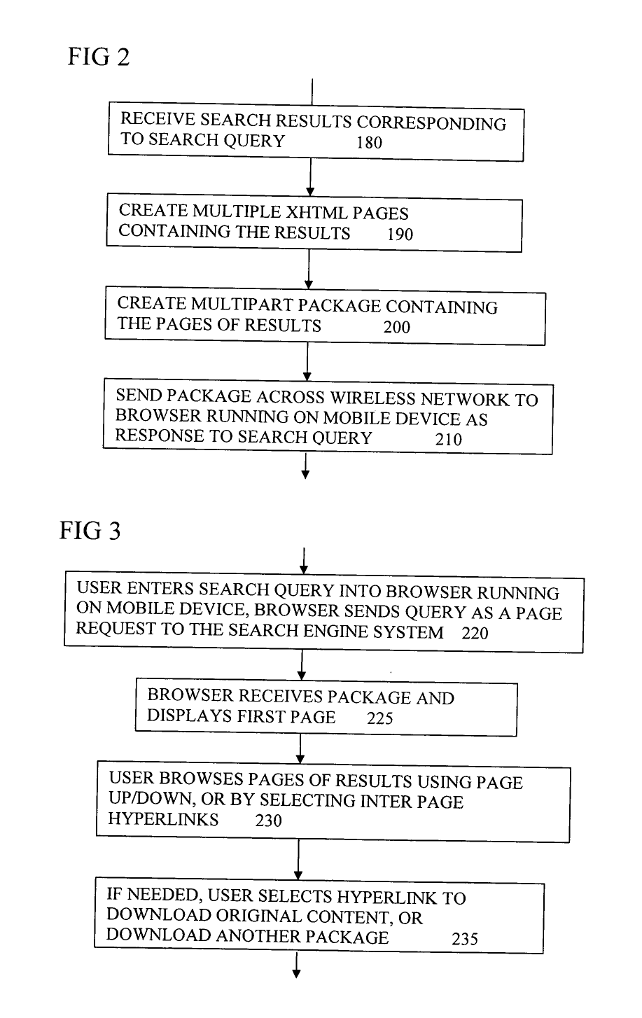

To reduce the frustrations of the delays implicit in this process, the query server is arranged to send a package of multiple pages of results which can be browsed by a user without needing multiple request and download cycles. As shown in FIG. 2, the query server at step 180 receives search results corresponding to the query. At step 190, the server creates multiple pages defined in a mark up language such as XHTML or HTML, containing the results. At step 200, the server creates a package containing the pages of results. At step 210 the package is sent across the wireless network to the browser running on the mobile device, as a response to the search query. Many variations and additional steps can be added to these basic operations of the query server.

Some of the principal operations at the user side are shown in FIG. 3. A user selects a search option, and the browser running on the mobile device typically displays a search query entry form. At step 220, a user enters a search query into the browser. The browser forwards the query as a page request to the search engine system. (In principle the query could be entered elsewhere such as a desktop computer, for sending results to the mobile device). The browser receives the package and displays a first page at step 225. At step 230, the user can browse through the pages of results using page up or page down or other page selection inputs, such as inter page hyperlinks, without the need for a download across the wireless network for each page. At step 235, if needed, the user can select a hyperlink to download content based on the search results, or can select a download of another package of results. Again there can be many variations and additional steps. Embodiments can be implemented using all the components described in more detail in the previous applications “Processing and Sending Search Results over a Wireless Network to a Mobile Device” and “Display of Search Results on Mobile Device Browser with Background Process”, but with a server component that packages the results up as a multiple page package instead of a single XHTML page.

One type of package which is currently supported by many browsers on mobile devices is multipart MIME. It is known to use MIME to extend the format of Internet email to allow non-ASCII textual messages, non-textual messages, multipart message bodies, graphics, images and so on in message headers. MIME are a set of standards defining a message representation protocol. These standards have grown up since 1982 through a number of RFC's (Request for Comments). Notable amongst these are August 1982 RFC822 Standard for the format of ARPA Internet Text Messages, September 1993 RFC1521 Mechanisms for Specifying and Describing the Format of Internet Message Bodies, and more recently RFCs 2045 to 2049. Multipart MIME is a standard used for MMS (Multimedia messages) as a way of transmitting multiple objects of differing types in a single package. It is not used at all for desktop browsing, but many microbrowsers for handheld mobile devices do support multipart MIME packages. At least some of the embodiments exploit a recognition that multipart MIME packages which are currently used in mobile browsing for packaging a single XHTML page with any images it uses, can be used for other purposes.

By having multiple XHTML pages contained within a single multipart MIME structure, together with all the images that all the pages need, search results can be presented on many mobile devices without always needing a custom application, and with a reduced number of download delays.

Compared to having all the results in “one big page” as described in above referenced earlier applications, multiple pages contained within a single multipart MIME structure has a number of consequences or advantages as has been discussed above. At least some of the results can be displayed one per page. This can equate to a screenview, or the page boundaries can be smaller or larger than a screenview. If each result is displayed in a true page, this means that:
each result page can itself be scrolled if necessary, where that scrolling is limited to that result and doesn't confusingly let the user move into the next result,
each result page can use all 12 access keys (keypad shortcuts to hyperlinks) where previously the set of 12 keys was shared across all sections of the “one big page”,
each result page can use the title bar displayed in many mobile browsers (set by the <title> XHTML tag), where previously one title had to be shared by all results,
navigation between pages can be arranged in XHTML more naturally with standard page links as opposed to the less reliably implemented (varies from browser to browser) bookmark, or anchor, links within the same page. Proper page links also means the browser back button works perfectly.

FIG. 4 shows schematically an example of a package at two stages of its processing by the query server. A first stage is a standard XSLT transform of the raw search results to form a MIME-ready package 260. It contains XHTML page 1 (which contains an instruction to insert images A and B), XHTML page 2, (which contains an instruction to insert an image C), and page 3, and optionally other results as desired. The package at this stage refers to the images but does not contain them. The search results in this example are in the form of objects delineated by a “start” and “end object” indication. The images are stored separately or retrieved later when needed.

After the second stage, a post processing step using a custom transform, the resulting package is shown as Final CSP 262. In this case, the XHTML items are shown as page 1, page 2 and page 3, and the image objects A, B and C (in this example .PNG and .JPG files) have been retrieved (and optionally scaled or processed) and are included explicitly in the package. The packaging can optionally include identifiers of the package, of each page, inter page navigation tools and so on. The page boundaries need not coincide with search result objects, nor with the size of a screenview of the mobile device.

The package can have a MIME type of either multipart/x-mixed-replace, multipart/related, or multipart/mixed depending on which is supported in the browser of the handset that is issuing the search request.

A package in the form of a MIME document typically has:

A number of top headers describing sender, date, MIME version, distribution, subject, importance, priority, and sensitivity of the document, and a “Content-type” header describing the document as MULTIPART/MIXED or other type. This means that the document may contain more than one piece (for instance some text and an attachment) and that the single pieces may have different types. The same header can contain another keyword, BOUNDARY to define the boundary line that will be used to separate the parts, such as pages and images to be displayed with the text.

An example of a package in the form of a multipart MIME document is as follows. Each package needs a header with at least the following fields:
Content-Type: MULTIPART/MIXED;
BOUNDARY=“-PART.BOUNDARY.1”

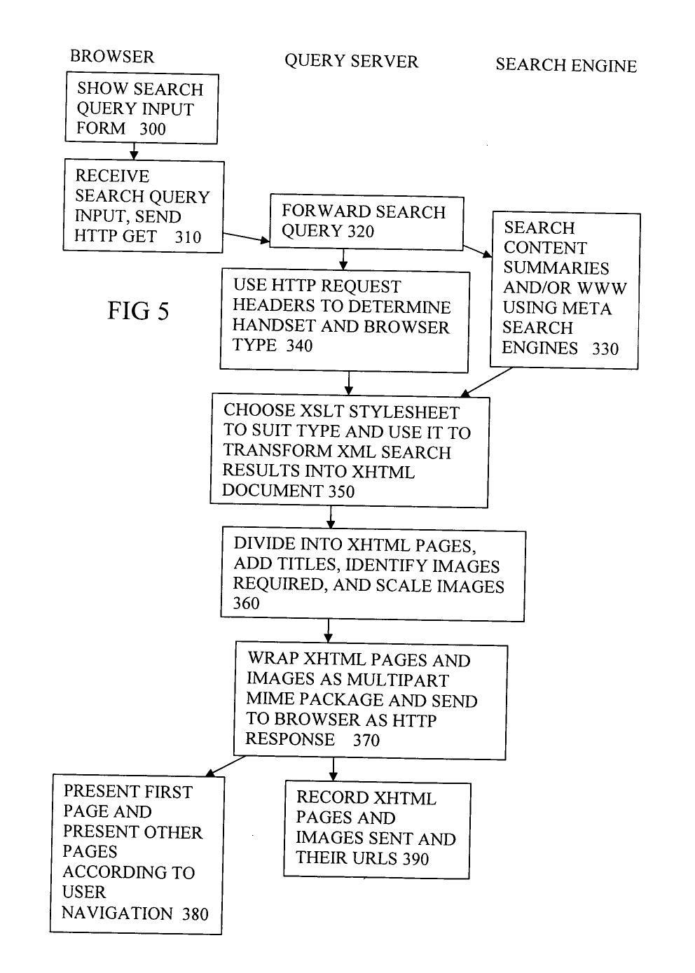

Each object (page, image etc) contained in the package needs a boundary followed by the appropriate header fields, e.g. for an XHTML page:
Content-Type: text/html
Content-Location:
   examplePageFileName.html
   FIG. 5 Embodiment Using Stylesheet, Image Scaling, and Supporting Bookmarking

Bookmarking: A notable consequence of adding page boundaries is that when the browser is on a page that was delivered within a multipart MIME package, the URL for that page is not necessarily a URL that can be loaded directly from the server. Hence if the user tried to bookmark an individual result, and later reloaded that bookmark, to request it be downloaded again, the server may not be able to respond as the original page never existed on its own as online content, only as part of the multipart package. Therefore, to support bookmarking, the server can be arranged to record URLs of packages and of individual pages inside multipart MIME packages. It can be arranged to serve individual results using the same URL as that which the browser will assume when it receives a result inside a multipart MIME package. There are a number of ways of achieving this. In principle it can be achieved either by caching the multipart result package, by caching the individual pages of the result package, or by building the requested page on demand when the URL is received, if sufficient information is recorded. An advantage of rebuilding is that any content which has changed since the page was first viewed, can be shown in the rebuilt page.

In a multipart MIME package, each component HTML document is given a name (the Location field). This is used as a relative path from the URL that was used to get the multipart package. For example, if a link to fetch a package was described in HTML as:
http://jamtap.com/query.jsp?term=london

Then the browser will treat any relative URLs as relative to the path:
http://jamtap.com/

So, if in the multipart package, component pages are given names like “page1.html”, then the browser will think the full URL for this page is:
http://jamptap.com/page1.html.

The server therefore needs to cache page1.html at that location, but this leads to a potential conflict as the next search that is performed will also have a “page1.html” that it needs to cache in the same location.

The server therefore needs to be more clever in how it sets up the names of components of multipart MIME packages, and should insert a unique identifier. This could be an 8-character string of alphanumeric characters, and could be used as the filename for the page, or as a directory in the path to the page, eg:
page1.html is now named 87Y43F93.html or 87Y43F93/page1.html.

The bookmark, and address to cache this page at, would then be:
http://jamtap.com/87Y43F93.html, or http://jamtap.com/87Y43F93/page1.html.

The server is then free to cache different search results at different unique locations.

Stylesheets:

Another notable feature is how the package may be tailored to suit different mobile devices. XSLT is a convenient way to generate XHTML that is specifically tailored to the target device. This means the search engine (or any server) only has to store or generate a single flavour (or XML Schema) which can then be tailored to fit using a stylesheet relevant to the target device.

XSLT stylesheets describe a transformation from one XML document (the input) to another (the output). The output of an XSLT transformation is a single XML document. However, with the multipart MIME packages, multiple XML documents (the XHTML pages) are required to be sent in response to the browser request. While this could obviously be achieved by running the XSLT transformation per page, this has the drawback that an XSLT stylesheet is required for each output page. A more efficient solution is to use the XSLT stylesheet to generate a single output document that is itself one big document containing all the individual pages. A simple post-processing (ie after the XSLT transformation process) step can then be taken to split up this single output document into its individual pages.

Image Scaling:

XSLT stylesheets can only output text, typically XML text. This is perfect for HTML or XHTML pages but of no help to images whose data is binary. XSLT can insert standard HTML <img> tags in output documents and these can set the size of the image, however, this is only a reference to an image that is assumed to be available.

By extending the post processing step (ie as above, the post-transformation process), <img> tags inserted by the XSL can be located and interpreted. It is then possible to decide not only which images (as above) but also at what size they should be scaled to before insertion into the multipart MIME package.

Either the original <img> tags themselves can be searched for in this step, or the XSLT can be written such that additional tags specific to the post-processing step are inserted, e.g. <INSERT-IMAGE w=“30” h=“40” crop=“top-center”. These tags are easy to locate (no understanding of HTML is required in the post-processor therefore) and can carry additional instructions. In this example, the desired cropping is indicated.

This scheme therefore gives control to the XSLT stylesheet, not just over the HTML or XHTML, but also the nature of the output images. The backend server that is supplying the “raw” search results then only needs to supply images in raw form with no requirement to anticipate which sizes/scales/cropping different devices may require.

This device specific information instead can reside solely within the XSLT stylesheet. This makes it easier to manage, which can enable easier adaptation of the search service to any new mobile devices which become popular.

FIG. 5: Summary of Processing Steps

As shown in FIG. 5, actions of the browser are shown in a left hand column, actions of the query server in a central column, and actions of a search engine in a right hand column. Time flows down the figure. At step 300, the browser shows a search query entry form. The user enters a search query into the form. The browser recognizes the search query input and issues an HTTP GET to the query server at step 310. The query server forwards the search query at step 320 to a back end search engine, which identifies more than enough results (than required for the eventual package) and passes these back to the query server at step 330.

The query server (or as delegated to a “result presentation server”) uses the original HTTP request headers to determine the handset and browser type at step 340. Using the handset/browser type, the query server decides which XSLT stylesheet to use in the construction of a response package, based on search results in XML form. At step 350 the chosen stylesheet is used to transform the search engine results into a single XHTML document.

The single document is post-processed to divide it into individual HTML or XHTML pages, identify the set of images required, and generate correctly scaled instances of those images at step 360. The collection of HTML or XHTML pages and images are wrapped as a multipart MIME package and sent back to the browser as an HTTP response at step 370. The user can navigate the pages in the result package as if browsing locally (i.e local to the handset) cached pages, as shown by step 380. The collection of html pages and images are recorded at step 390 and optionally cached at the right URLs so that browser bookmarks will work, as described above.

FIG. 6 Appearance of Screenview of Package

FIG. 6 shows a schematic view of the appearance of a screenview movable to view part of a package having pages having results, some of which have images. This shows a CSP 261, which contains a number of pages including page 1 430, and page 2, 470. Each page includes one or more result objects. Page 1 includes result 1, 440, and result 2, 450. Result 1 includes image 460. Page 2 includes result 3, 480, and result 4, 500. A current screenview 400 is shown as encompassing most of page 2, to show result 3 and part of result 4. The screenview could be scrolled down to show result 4, or a page navigation key could be selected to show a first part of page 1, to show result 1.

Other Applications—Mosaic Images (e.g. Maps, Diagrams, Pictures)

This technique of multi page download packages could also be used to provide large images in mosaic form which can be more easily navigable by the mobile user. An example is a map, though it is also applicable to any other pictures or diagrams which a user may wish to view a portion and pan across or up/down, or view at different levels of zoom. The mobile user downloads a multipart MIME package containing a collection of HTML or XHTML pages and embedded images. Each page corresponds to a section of a map. One page might be the map overview, another might be the magnification of the centre region, another might be the magnification of the western region of the overview, and another page might contain info about local services and points of interest in the form of an overlay. To view the map with different overlays or different levels of detail, or different annotations, multiple pages with the same map image but with different overlays or annotations can be provided in the same package. The package can provide inter page navigation to change the annotations or overlays without changing the map view. The user can navigate from the overview page to any page in the package without having to incur a delay from over-the-air downloading of the pages. This gives a much better user experience for inspecting maps on a mobile handset.

FIGS. 7, 8, Generating Content Summaries

Another notable combination is multi-page packages and results in the form of content summary objects. As discussed above, content summary objects can provide more dense information, and more relevant information than the source online content. This combination can help reduce the number of download cycles when browsing results of a search query by receiving results on a wireless device. The package can include a content summary for each item of the search results, including multimedia items and a number of other features to make browsing more rapid or convenient, especially to overcome physical limitations of handheld mobile devices with limited capabilities for display or for scrolling or selecting, and the physical limitations of the wireless network. This will be referred to as a content summary package (CSP). The package can be arranged as a page extending over a number of browsable screenviews. This can provide more information and/or a more convenient arrangement for browsing, compared to the normal annotated result list provided by traditional search engines. The quantity and presentation of the summary of each content item can be tailored to suit the device to best take advantage of the mobile device physical format. For example each content summary could be arranged to fill a small format screen of a handheld mobile device. The content summarized can be Web pages, WAP pages, news items, sound or video clips or many other types of content for example. By providing a richer and better-structured summary than existing mobile search engines, a user can find a desired or optimum page more quickly. Particularly where background processes can be used to enable more rapid browsing of many summaries, the mobile search can be more efficient and less frustrating for the user.

A set of navigable pages is one possible presentation format of a content summary package, useful to take advantage of widespread use of browser software to read hypertext pages in mark up languages, such as the standard XHTML microbrowser built into many mobile device. If this is the chosen presentation format, then the screenview is the currently visible part of the package, and may correspond to the presentation format of an individual content summary.

Other presentation formats are possible, using for example a custom Java application client downloaded onto the device. In this case, a content summary package can be formed within an XML document or even within a binary file format, and individual content summaries could be expressed likewise as (smaller) XML documents or binary files.

Screenviews are intended to encompass a portion of a web page (or other page based display medium) suitable for display by a browser or equivalent software on a mobile device. The size of a screenview can be determined dynamically by discovering the actual size of the display of the device being used, or by taking a default value based on estimates or typical devices used most frequently. A margin can be provided around the screenview to allow for different actual display sizes. The content summary sizes can be chosen to substantially fill a screenview of the mobile device. A next screenview can be selected by a user for display by scrolling, or more conveniently in some embodiments by using a hyperlink. Users can access a start point of the information by clicking on a button or a hypertext link embedded elsewhere in the web page. This is often much more convenient than scrolling, which is too time consuming if there are multiple screenviews to scroll through, or if it is desired to flick backwards and forwards between an overview and content summaries for example.

The package of screenviews can be implemented as a set of pages in XHTML Mobile Profile for example. As indicated by the W3C website, XHTML Mobile Profile is one in a series of XHTML specifications. The XHTML Mobile Profile document type includes the minimal set of modules required to be an XHTML Host Language document type, and in addition it includes images, forms, basic tables, and object support. It is designed for Web clients that do not support the full set of XHTML features; for example, Web clients such as mobile phones, PDAs, pagers, and settop boxes. The document type is rich enough for content authoring. XHTML Mobile Profile is designed as a common base that may be extended by additional modules from XHTML Modularization such as the Scripting Module. Thus it provides a common language supported by various kinds of user agents such as browsers. It is useful if the page format can be read and presented by many different versions of “legacy” browsers to maximize the user base among existing mobile telephone users for example.

An overview of search engine activities can be summarized as follows:
Spider the Web as conventional search engines do.
Extract content summaries from each web page based on a category of content found on that page (e.g. text, image, video)
Store and index summaries in an indexed database.
Receive a query, obtain search results from the indexed database.
Customize the display of the content summaries to the mobile device and/or its browser,
Send a set of summaries to user as a package for a browser to present, optionally include advertising material and other information of potential interest, together with code for background processes.
Display using browser on the mobile device, starting with a short overview of items in the results, optionally including an entry to the advertising material, using background processes to reduce delays.
Subsequently display each larger summary in response to input such as clicking on a URL, on a button, or scrolling by the user.

This can help overcome problems such as mobile devices having small screen sizes, and XHTML being limited in capability. It need not be limited to particular mobile device characteristics or browser. It helps overcome the problem that network fetches are time-expensive, and that even newer faster networks will suffer from congestion at peak times and show latency effects.

The generation of these content summaries can be carried out offline or on demand, or some combination of these options. If done offline, they can be stored in an indexed database which is integrated within an overall search engine architecture, so that the summaries may be more rapidly retrieved in response to a user query. If the summaries are generated on demand, this requires following the links in search results obtained from existing search engines, to obtain the whole content items, such as web pages. The system can optionally be set up as a metacrawler acting as a front end to existing search engines. The summaries can then be created from the whole content items obtained from multiple search engines.

Embodiments can provide a minimum system which streamlines the process of mobile search. It can be implemented as a metacrawler in front of existing search engines (e.g. Google™, Yahoo™, MSN™) or as a subsystem which is more tightly integrated into an overall search engine system. An additional level of summarisation of the original content items (whether they be Web pages, WAP pages, news items, sound or video clips, or local information such as e.g. yellow pages or white pages) can be created in addition to the normal annotated results list provided by search engines like Google. It transmits these content item summaries to the mobile device as a single-shot package (a content summary package or CSP) in response to a keyword-initiated search.

The additional level of content summaries gives the user sufficient information about the content he/she is seeking that he can have high confidence in it before clicking through to the underlying content item on the WWW. The system allows the mobile user to quickly navigate through a set of content summaries cached within the local device browser to find what they are looking for, without the need to incur expensive clicks over the mobile network. In this way the user experience of mobile search is dramatically improved.

CSPs can be implemented as HTML, XHTML Mobile Profile or XHTML Basic web pages, using either bookmarks or multipart messages, allowing the result set to be arranged as a stack of linked screenviews in the form of navigable pages.

The content summary package can be in a format suitable for the native browser on the device, or can use or include a separate software program running as a user application on the device. FIG. 7 shows an example of an arrangement for creating the content summaries. Web content on a web mirror 90 is fed to content summarisers 700 for summarizing a different category or type of content. So one content summariser produces web page content summaries, another produces WAP content summaries, another produces video content summaries, another produces music content summaries, another produces news content summaries. A useful source of information for creating these content summaries are microformats, RDF files and other information contributing to the so-called semantic web.

These content summaries are stored as content summary objects (CSOs) and stored in databases which are indexed. The indexes 710 are consulted when the query server 50 searches for relevant content summaries. The content summaries found are fed to the query server for incorporating into a package. A store 730 of device information and a store 740 of user history are provided to enable the query server to tailor the package. The query server can create the overview screenviews from the content summaries. The content summary database or index to it can store meta-data about its respective content item or the web page holding that item as follows. Such meta data might constitute one, some or all of the following aspects of a media item:
size
image/frame dimensions
length in time
CRC (cyclic redundancy check) over part or all of data
Embedded meta data, eg: header fields of images, videos etc
Media type, or MIME-type

The overview can be a conventional annotated list having brief descriptive information of up to 60 or so words on each item, plus other descriptive information such as the source web site, date, etc, or can be provided in other forms such as a non-annotated list, a list of groups of items, a multilevel list, capable of showing more or less information about each item or groups of items, or an array of thumbnail images, or a scrolling sequence of views of successive items, for example.

Content Summaries

A content summary can encompass an aspect of a web page (from the world wide web or intranet or other online database of information for example) that can be distilled/extracted/resolved out of that web page as a discrete unit of useful information. It is called a summary because it is a truncated, abbreviated version of the original that is understandable to a user.

Example types of content summary include (but are not restricted to) the following
Web page text—where the content summary would be a contiguous stretch of the important, information-bearing text from a web page, with all graphics and navigation elements removed.
WAP pages—where the summary would be the first dozen or so lines of a WAP page, including any images (since the images are small and already optimized for display on a mobile device).
News stories, including web pages and news feeds such as RSS—where the content summary would be a text abstract from the original news item, plus a title, date and news source.
Images—where the content summary would be a small thumbnail representation of the original image, plus metadata such as the file name, creation date and web site where the image was found.
Ringtones—where the content summary would be a starting fragment of the ringtone audio file, plus metadata such as the name of the ringtone, format type, price, creation date and vendor site where the ringtone was found.
Video Clips—where the content summary would be a small collection (e.g. 4) of static images extracted from the video file, arranged as an animated sequence, plus metadata

The collection of summaries is obtained by scanning the WWW and is then indexed and made available to the search service. The items scanned can include items from the deep web, that is dynamically generated web pages generated from live databases behind the web page, such as weather forecasts, travel timetables, stock quotes and so on. Search queries result in a collection of relevant content summaries being returned to the user. A notable advantage of obtaining, storing and sending results in content summary units rather than page units is that they can be adapted to different screen sizes more easily to make better use of the confines of the limited screen real-estate of a typical hand held mobile device. Further, the presentation of content summaries such as size, font size, colors or media types used for example, can be tailored depending on the characteristics (browser, screen colour depth and size, video capability, ringtone capability etc) of the user's device. The package size can also be tailored to suit the browser of the device, or characteristics of the wireless channel, such as bandwidth, latency or quality. For example an operator of the wireless network might have a network management system with live information about the currently available bandwidth or other channel characteristics for each connection. This could be passed to the query server, to enable it to dynamically decide how large the next package on that connection can be, and so decide how many content summaries or how large each summary can be without the user noticing undue delay. Furthermore, the size of a screenview can be adapted, to suit an actual display size or other factor for example. This might affect where hyperlinks are located in the page, if it is desired to present hyperlinks at the same place in each screenview, for ease of use.

This tailoring might be achieved by storing the content summaries in a device neutral representation (which could be XML but doesn't have to be) and then transforming them (possibly with XSLT) either on the fly (per request depending on the user's device) or preparing transformed content summaries in advance.

A second advantage to content summaries is that several can be collated together to form a package containing a number of screenviews, in other words a single CSP that can be transmitted more efficiently to a wireless device. This means that several results can be downloaded to a device whilst only incurring one instance of the network latency. The user can quickly scroll, or page, through the result set. This is in contrast to traditional search results that require the user to click on each search result and wait for it to download before being able to glean any information or determine that the result was not relevant. These features can be combined with using a formatting template as described above which can be reused, to provide further options for altering the screenview by swapping new data into the page.

Content summaries can be grouped into categories, e.g. images, webtext, ringtones, videoclips, news items, addresses. Such categories can be based on content categories or on media type. Categories can be used to assist in the presentation of sets of results to a search query. The user could be offered the choice of category of result before being presented with the results of a particular category. Alternatively, the user could have already expressed a preference (either via their mobile device, or using a desktop to access their mobile-search account preferences), and results from the user's preferred category presented first.

Content summaries can be extracted from web pages containing any machine readable content format. This includes all flavours of HTML, JavaScript, FLASH, PDF, Microsoft Office documents etc. Content summaries might be the whole page if the page is small and has a high information density, or it might just be a small subset of the content of the page.

Content summaries might be inserted by other means than by automated scanning (crawling) of the web. E.g. by manual insertion or custom conversion of third party databases. Content summaries are primarily a way of storing units of information that can be collated and displayed conveniently on a mobile device. A good application of these is in the implementation of a web search service for mobile devices where a lack of alternative means of finding and displaying the information exists. A second application is in access of an online store or marketplace (e.g. Ebay™) where a mobile user wishes to search for a multitude of candidate items to bid on or purchase.

Individual content summaries can be linked within Summary Packages using intra-page hyperlinks (called bookmarks in HTML, XHTML Basic and XHTML Mobile Profile). Clicking on a bookmarked link is then just a jump in the view of the current page and does not involve the browser returning to the network to fetch the next page. The user receives this Summary Package (actually a stack of web screenviews) in a single network fetch-response cycle and can then browse through the contained results with quick clicks on the intra-page links.

In XHTML Mobile Profile the anchor tag <a> with the href attribute set to a bookmark can be used to implement this method. The effect of this navigation method is to enable page-by-page scrolling rather than the pixel-by-pixel or line-by-line scrolling normally offered via the device's up/down/left/right navigation keys.

Bookmarks are a standard and well understood technique in desktop web pages. They are normally used to offer fast links to specific sections of a large documents. However, bookmarks have not often been used to link consecutive screenfuls of content—this being especially useful on a mobile device which typically has a reduced keyboard with no page up or page down key, as well as a small format display.

Content Summaries are a very convenient unit for each screenview in a linked stack of search results. Each screenview is then a candidate result item for the search query, and the set of results can be stepped through with a quick-to-load (because it's just a move) click per result. This clicking can step through results of different types (for example different media categories such as text or images) simply by arranging for the stack of content summaries (screenviews) to come from these different categories.

CSPs can incorporate sponsored links similar to those used in the desktop search service environment. Where the advertiser has mobile-specific webpages, these sponsored links can point directly at these pages. However, where an advertiser does not have mobile-specific web pages, they can instead provide advertising collateral to the search service. For each content summary item, a hyperlink having a URL can be provided to let the user click down to the underlying content item found on the WWW. Each and every page in this system can have a single AdLink. When a user clicks on an AdLink, an AdPage is presented, which is a textual page which is carried in the payload of the search query response page. A link at the bottom of the AdPage is provided to make a request over the wireless network to load further advertising material.

FIG. 8 shows some of the principal actions of the system of FIG. 7. At step 500, a subset of the web is crawled. At step 510, for given category of content, a predetermined extractor is used to extract useful information and reduce formatting overhead. At step 520, a device neutral content summary object is created and stored in an indexed database. In response to a search query, results are returned as ranked content summary objects at step 530. The query server transforms the results according to mobile device characteristics at step 540. At step 550, the query server creates a multi page package of results and sends it to the mobile device for the user to browse the pages.

Any of the additional features can be combined together and combined with any of the aspects. Other advantages will be apparent to those skilled in the art, especially over other prior art.

1. A query server arranged to provide a mobile search service, and arranged to respond to a search query by fetching search results corresponding to the search query, the query server being arranged to prepare a package containing more than one page defined by a mark up language, the pages containing the search results, and send the package to a mobile device, across a wireless network, for presentation by a browser running on the mobile device capable of selectively presenting the pages.

2. The server of claim 1, wherein the package comprises a multipart MIME document.

3. The server of claim 1, arranged to insert in the package any one or more of: one or more page boundaries between results, one or more page boundaries to coincide substantially with screenview boundaries, inter page navigation hyperlinks, access key navigation hyperlinks, a title bar for one or more of the pages.

4. The server of claim 1 arranged to maintain a persistent record of the pages sent.

5. The server of claim 1 arranged to fetch the search results from a database of content summary objects extracted from online content.

6. The server of claim 1 arranged to transform the search results.

7. The server of claim 6 arranged to insert page breaks after the transformation.

8. The server of claim 6, wherein the package contains one or more images, for inserting into the pages, and the transforming involves scaling one or more of the images.

9. The server of claim 1 arranged to fetch the search results in XML form, and arranged to use an XSLT stylesheet for the transformation, to output HTML or XHTML for the pages.

10. The server of claim 1, the search results comprising an image for presentation as a mosaic of pages, and the server is arranged to convert the image into pages each having a portion of the image.

11. A method of providing a mobile search service in response to a search query, having the steps of: fetching search results corresponding to the search query, preparing a package containing more than one page defined by a mark up language, the pages containing the search results, and sending the package across a wireless network to a mobile device, for presentation by a browser running on the mobile device capable of selectively presenting the pages.

12. The method of claim 11, having the step of inserting in the package any one or more of: one or more page boundaries between results, one or more page boundaries to coincide substantially with screenview boundaries, inter-page navigation hyperlinks, access key navigation hyperlinks, a title bar for one or more of the pages.

13. The method of claim 11 arranged to fetch the search results from a database of content summary objects extracted from online content.

14. The method of claim 11 having the step of transforming the search results according to a characteristic of the user's mobile device.

15. The method of claim 14 having the step of inserting page breaks after the transformation.

16. The method of claim 14, wherein the package contains one or more images, for inserting into the pages, and the transforming involves scaling one or more of the images.

17. The method of claim 11 having the steps of fetching the search results in XML form, and using an XSLT stylesheet for the transformation, to output HTML for the pages.

18. The method of claim 11, the search results comprising an image for presentation as a mosaic of pages, and the method having the step of converting the image into pages each having a portion of the image.

19. A program on a computer readable medium arranged to carry out the method of claim 11.

20. A method of using a mobile search service having the steps of: sending a search query to the mobile search service, receiving at a browser running on a mobile device, a package containing more than one page defined by a mark up language, the pages containing search results corresponding to the search query, and using the browser to selectively present the pages.
